(19) United States
(12) Patent Application Publication
(10) Pub. No.: US 2013/0128309 A1
(43) Pub. Date: May 23, 2013

(54) PRINT SYSTEM AND PRINT DATA GENERATION APPARATUS

(71) Applicant: Sharp Kabushiki Kaisha, Osaka (JP)

(72) Inventor: Masaki Higashiura, Osaka (JP)

(73) Assignee: SHARP KABUSHIKI KAISHA, Osaka (JP)

(21) Appl. No.: 13/678,696

(22) Filed: Nov. 16, 2012

(30) Foreign Application Priority Data
Nov. 18, 2011 (JP) 2011-253060

(51) Int. Cl. G06K 15/00

(52) U.S. Cl. CPC G06K 15/00
USPC 358/1.15

(57) ABSTRACT

A print system includes a print data generation apparatus that is activated through an inputted activating instruction and generates print data containing image data and configuration information at the time of printing an image based on the image data, and a print apparatus that prints an image based on the print data generated by the print data generation apparatus. The print data generation apparatus has an acquisition section that acquires image data according to the inputted activating instruction, a generation section that generates print data containing the image data acquired by the acquisition section and predetermined configuration information, and a sending section that sends the print data generated by the generation section to the print apparatus. The time taken from the operator inputting printing instruction to the print data generation apparatus to printed image being outputted from the print apparatus is short.

### CROSS-REFERENCE TO RELATED APPLICATION

This non-provisional application claims priority under 35 U.S.C. §119(a) on Patent Application No. 2011-253060 filed in Japan on Nov. 18, 2011, the entire contents of which are hereby incorporated by reference.

### FIELD

The present invention relates to a print data generation apparatus generating print data to be sent to a print apparatus, and a print system including the print apparatus and the print data generation apparatus.

### BACKGROUND

Conventionally, a print data generation apparatus for sending print data to a print apparatus activates a printer driver through the application being used by an operator. The printer driver to which an activation instruction is inputted generates print data based on image data opened by the application and print configuration information inputted by the operator after the activation processing (for example, see Japanese Patent Application Laid-Open No. 2004-78556). As the operator inputs a printing instruction, the print data generation apparatus sends the generated print data to the print apparatus.

The print apparatus receiving print data generates image data for printing from the received print data through bitmap expansion by a raster image processor (hereinafter referred to as the “RIP”). The print apparatus prints an image on a media such as paper based on the generated image data for printing according to the configuration information contained in print data.

The bitmap expansion processed by a RIP takes time. After the operator inputs the printing instruction to the print data generation apparatus, the print data generation apparatus is required to generate print data and send to the print apparatus as quickly as possible for reducing the time duration from printing the image to outputting printed image performed by the print apparatus.

With regard to the network printer system described in Japanese Patent Application Laid-Open No. 2004-78556, each time the operator inputs the requirement information (configuration information), print image (print data) is generated side by side, and then the generated print image is sent to the print apparatus after the input is completed. As a result, sending print data can be earlier as compared with the case where print data is generated after the input is completed.

### SUMMARY

However, with regard to the network printer system described in Japanese Patent Application Laid-Open No. 2004-78556, the information such as print data is not sent until the operator completes the input of configuration information. With regard to a point in time before the operator inputs the printing instruction, if the print apparatus generates the image data for printing, the time taken can be further reduced.

The present invention has been devised in view of such circumstance, it aims to provide a print system to reduce the time taken from the operator inputting the printing instruction to the print data generation apparatus until the printed image from the print apparatus is outputted. Similarly, the present invention aims to provide the print data generation apparatus for sending print data as early as possible.

The print system related to the present invention is a print system including a print data generation apparatus activated through an inputted activating instruction and generating print data containing image data and configuration information at the time of printing an image based on the image data and a print apparatus printing an image based on the print data generated by the print data generation apparatus. With regard to the print system, the print data generation apparatus includes acquiring means for acquiring image data according to the inputted activating instruction, generating means for generating print data containing the image data acquired by the acquiring means and predetermined configuration information, and sending means for sending the print data generated by the generating means to the print apparatus.

In the present invention, the print data containing the predetermined configuration information is generated and sent after the activating instruction regardless of whether configuration information is inputted or not. Therefore, the time taken from the activation to sending can be reduced.

With regard to the print system related to the present invention, the print apparatus includes receiving means for receiving print data sent from the sending means, image generating means for generating image data for printing based on the print data received at the receiving means, and storing means for storing the image data generated by the image data generating means.

In the present invention, the print apparatus generates and stores image data for printing based on the received print data. The time taken from the print data generation apparatus sending print data containing the predetermined configuration information to the image data for printing being generated can be reduced.

With regard to the print system related to the present invention, in a case where an instruction for printing based on print data containing the predetermined configuration information is inputted to the print data generation apparatus, the sending means sends a printing instruction to the print apparatus, and the print apparatus includes printing means for printing, based on the predetermined configuration information, an image according to the image data stored in the storing means in a case where the receiving means receives the printing instruction.

In the present invention, the printing instruction of the printing based on the predetermined configuration information is sent according to the printing instruction inputted by the operator. In a case where it is printed based on the predetermined configuration information, the printing can be performed early because the image data already being stored in the storing means is used.

With regard to the print system related to the present invention, in a case where configuration information different from the predetermined configuration information is inputted to the print data generation apparatus, the generating means further generates print data containing image data acquired by the acquiring means and the inputted different configuration information, and in a case where the receiving means receives print data containing the configuration information different from the predetermined configuration information, the printing means further prints an image based on the received print data.

In the present invention, the print data generation apparatus generates print data containing configuration information different from the predetermined configuration information, and the print apparatus prints the image based on the generated print data. Therefore, the printing based on the configuration information different from the predetermined configuration information can be performed based on the inputted configuration information.

With regard to the print system related to the present invention, the print apparatus includes judging means for judging whether the image data generated from the received print data is the same as the image data stored in the storing means or not by comparing the configuration information contained in the print data received at the receiving means with the predetermined configuration information, and the printing means prints the image data stored in the storing means based on the configuration information contained in the received print data in a case where the judging means judges that both image data are the same.

In the present invention, the print apparatus prints an image of the image data for printing stored in the storing means based on the configuration information contained in the received print data. Accordingly, the printing can be done in short time than in a case where new image data for printing is generated based on the received print data.

The print system related to the present invention is a print system including a print data generation apparatus generating print data containing image data specified by inputted information and configuration information at the time of printing an image based on the image data and a print apparatus printing an image based on the print data generated by the print data generation apparatus. In the print system, the print data generation apparatus includes acquiring means for acquiring image data specified by the inputted information, generating means for generating print data containing the image data acquired by the acquiring means and predetermined configuration information, and sending means for sending the print data generated by the generating means to the print apparatus.

In the present invention, the print data containing the predetermined configuration information is generated and sent regardless of whether the configuration information is inputted or not. Accordingly, the time taken until the print data generation apparatus sending print data can be reduced.

The print data generation apparatus related to the present invention is a print data generation apparatus that is activated through an inputted activating instruction and generates print data containing image data and configuration information at the time of a print apparatus printing an image based on the image data. The print data generation apparatus includes acquiring means for acquiring image data according to the inputted activating instruction, generating means for generating print data containing the image data acquired by the acquiring means and predetermined configuration information, and sending means for sending the print data generated by the generating means to the print apparatus.

In the present invention, the print data containing the predetermined configuration information is generated and sent after the activating instruction regardless of whether configuration information is inputted or not. Accordingly, the time taken from the activation to sending can be reduced.

The computer program related to the present invention is a computer program to cause a computer to activate through an inputted activating instruction and generate print data containing image data and configuration information at the time of a print apparatus printing an image based on the image data. The computer program causes the computer to perform an acquisition step of acquiring image data according to the inputted activating instruction, a generation step of generating print data containing the image data acquired in the acquisition step and predetermined configuration information, and a sending step of sending the print data generated in the generation step to the print apparatus.

In the present invention, the print data containing the predetermined configuration information is generated and sent after the activating instruction regardless of whether configuration information is inputted or not. Accordingly, the time taken from the activation to sending can be reduced.

According to the print system of the present invention, the print data generation apparatus generates and sends print data containing predetermined configuration information after the activating instruction regardless of whether configuration information is inputted or not. Accordingly, the time taken from the operator inputting a printing instruction to the image printed from the print apparatus being outputted can be reduced.

According to the print data generation apparatus of the present invention, the print data containing predetermined configuration information is generated and sent after the activating instruction regardless of whether configuration information is inputted or not. Accordingly, the present invention provides the print data generation apparatus in which the time taken from the activation to sending can be reduced.

The above and further objects and features of the invention will more fully be apparent from the following detailed description with accompanying drawings.

### BRIEF DESCRIPTION OF THE DRAWINGS

FIG. 1 is a schematic diagram showing a functional configuration of an embodiment of a print system related to the present invention.

FIG. 2 is a flowchart showing a processing executed by a PC.

FIG. 3 is a flowchart showing a processing executed by a print apparatus.

FIG. 4 is a flowchart showing a printing process based on the printing instruction executed by the print apparatus.

FIG. 5 is a flowchart showing a printing process based on the printing instruction executed by the print apparatus.

FIG. 6 is a flowchart showing a process of discarding image data for printing stored in a storage section.

FIG. 7 is an explanatory view showing an example of an interface of a print driver.

FIG. 8 is a flowchart showing a process in a case where the sending of print data containing predetermined configuration information can be configured.

FIG. 9 is an explanatory view showing a screen for configuring sending of print data containing predetermined configuration information.

FIG. 10 is a flowchart showing a processing of generating image data for printing based on a direct print application and the print apparatus.

FIG. 11 is an explanatory view showing an interface of the direct print application displayed on a browser.

### DETAILED DESCRIPTION OF NON-LIMITING EXAMPLE EMBODIMENTS

An embodiment of the present invention is described in more detail hereinafter with reference to the drawings.

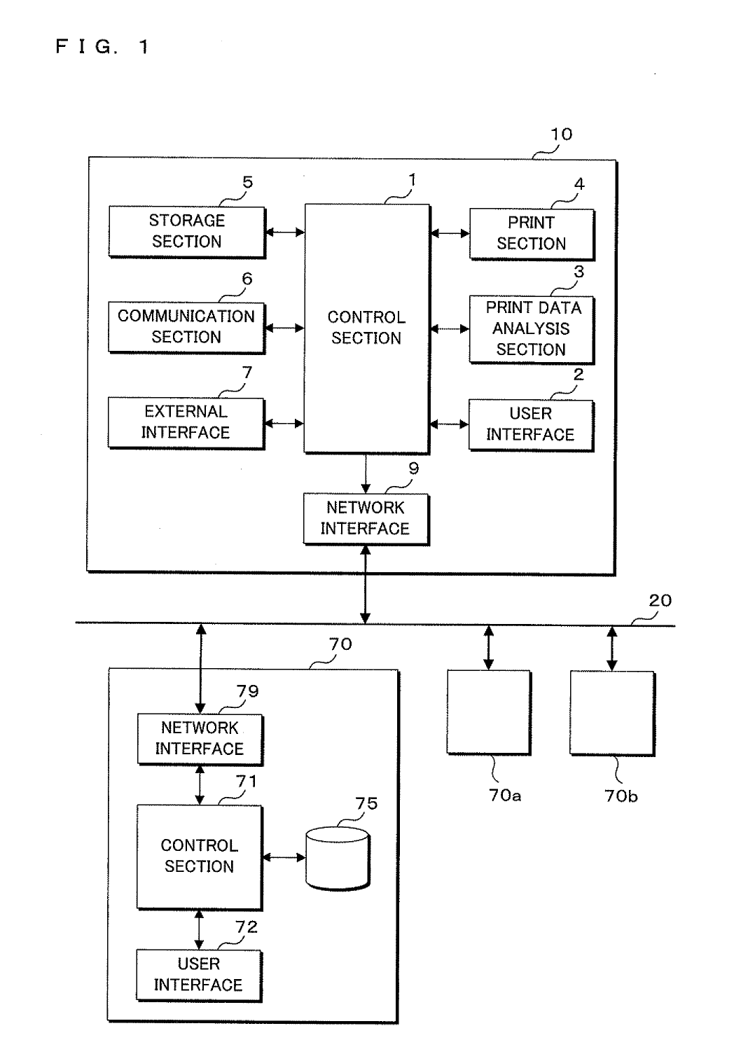

FIG. 1 is a schematic view showing a functional configuration of the embodiment of a print system related to the present invention. With regard to the print system of FIG. 1, a print apparatus 10 is connected to a personal computer (hereinafter referred to as “PC”) 70, a PC 70a, and a PC 70b through a local area network (hereinafter referred to as “LAN”) 20.

The PC 70, the PC 70a, and the PC 70b have a substantially similar function and configuration. The PC 70 is described hereafter. With regard to the PC 70, the operator inputs the information for specifying image data and the configuration information for printing, and then the print data containing the image data and the configuration information for printing is generated based on the inputted information and the like, then the generated print data is sent to the print apparatus 10. Additionally, the PC 70 sends a printing instruction to the print apparatus 10 based on the instruction for printing inputted by the operator.

The PC 70 includes a control section 71, a user interface 72, a storage section 75, and a network interface 79. These sections are connected to each other through a bus (not shown). The network interface 79 is further connected to the LAN 20.

The control section 71 performs control of each section in the PC 70. The user interface 72 receives an instruction from the operator, and the status of the PC 70 and the like is displayed with respect to the operator's instruction. The user interface 72, for example, is an input apparatus such as a keyboard and mouse as well as a display device such as a display. The storage section 75 stores the information processed by the control section 71 and the like. The storage section 75 is a memory, hard disk or the like. The network interface 79 is an interface at the time of performing communication with other apparatuses connected to the PC 70 through the LAN 20.

The print apparatus 10 includes a control section 1, a user interface 2, a print data analysis section 3, a print section 4, a storage section 5, a communication section 6, an external interface 7 and a network interface 9. The network interface 9 performs input and output of a signal with respect to the LAN 20, and is connected to other sections through a bus (not shown).

The control section 1 performs control in each section in the print apparatus 10. The user interface 2 receives an instruction from the operator and outputs to the control section 1 and the like. The user interface 2, for example, is an operation panel containing a liquid display device and a touch panel. The print data analysis section 3 is a RIP that analyzes print data and generates image data for printing.

The print section 4 forms and prints an image based on the image data for printing on a media. The storage section 5 stores image data and a variety of data processed by the control section 1. The communication section 6 performs communication with an external apparatus. The external interface 7 is an interface with an apparatus connected by a USB and the like. The network interface 9 is an interface at the time of performing communication with other apparatuses connected with the print apparatus 10 through the LAN 20.

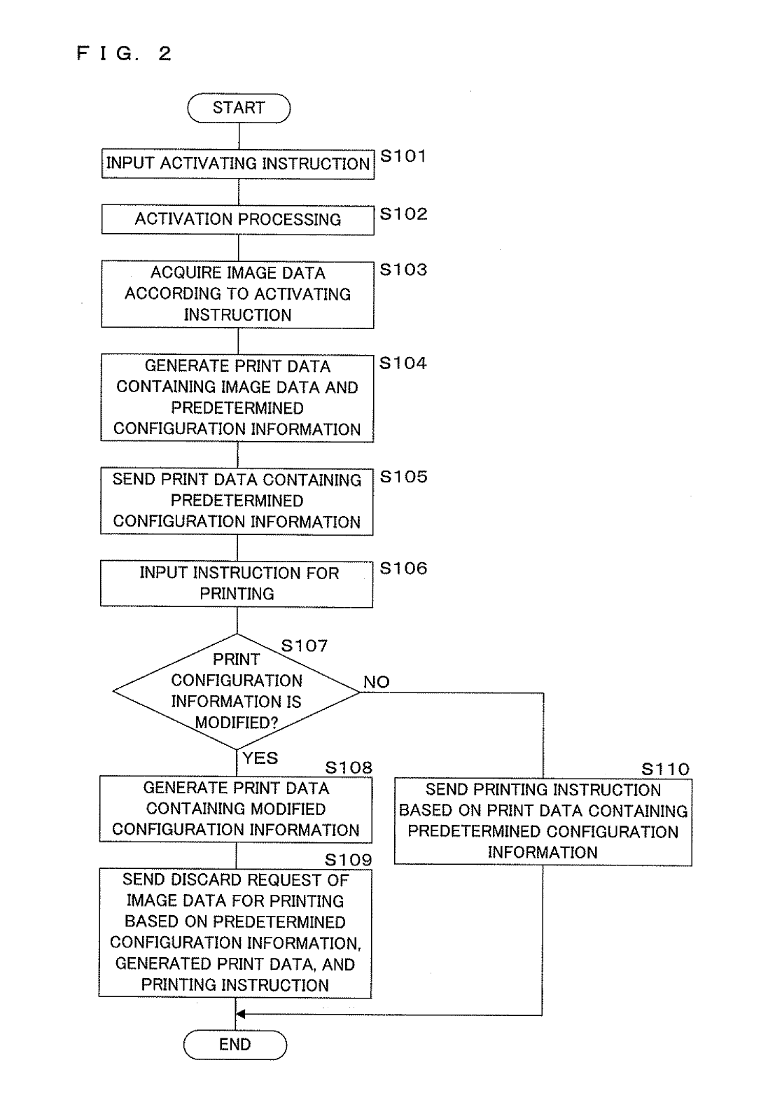

FIG. 2 is a flowchart showing a processing executed by the PC 70. With regard to FIG. 2, an activating instruction from the operator is inputted to the user interface 72 of the PC 70 (Step S101). More specifically, as the operator operates the user interface 72 such as a keyboard and a mouse, a printer driver is selected and the activating instruction is inputted from the application executed by the control section 71 of the PC 70. Thus, the activating instruction is inputted to the control section 71. Next, the control section 71 executes an activation processing for activating the printer driver (Step S102).

Next, the printer driver executed by the control section 71 acquires image data such as a document processed by the application to which the operator inputs an activating instruction with respect to the activating instruction inputted in Step S101 (Step S103). Next, the printer driver executed by the control section 71 generates print data containing the image data acquired in Step S103 and predetermined configuration information (Step S104). Next, the printer driver executed by the control section 71 sends print data containing the predetermined configuration information generated in Step S104 to the print apparatus 10 through the network interface 79 (Step S105).

After the print data is sent, the user interface 72 receives a printing instruction inputted by the operator, and then the received printing instruction is inputted to the printer driver executed by the control section 71 (Step S106). Next, the printer driver executed by the control section 71 judges whether the print configuration information is modified from the predetermined configuration information or not (Step S107). Namely, after the print data is generated in Step S104, it is judged whether configuration information different from the predetermined configuration information is inputted from the user interface 72 by the operator or not.

In a case where the print configuration information is modified (Step S107: YES), the printer driver executed by the control section 71 generates print data containing the modified configuration information (Step S108). Next, the printer driver executed by the control section 71 sends a request discarding generated image data for printing based on the print data containing the predetermined configuration information, the print data generated in Step S108, and the printing instruction to the print apparatus 10 through the network interface 79 (Step S109).

On the other hand, in a case where the print configuration information is not modified (Step S107: NO), the printer driver executed by the control section 71 sends the printing instruction based on the print data containing the predetermined configuration information to the print apparatus 10 through the network interface 79 (Step S110).

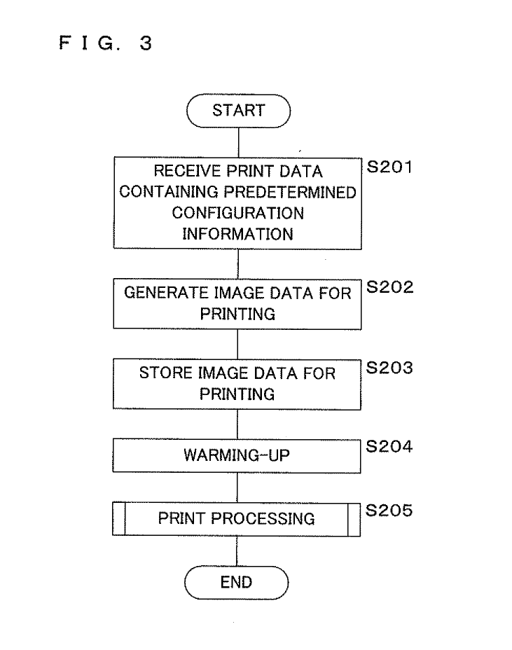

FIG. 3 is a flowchart showing a processing executed by the print apparatus 10. First of all, the control section 1 in the print apparatus 10 receives the print data containing the predetermined configuration information, which is sent in Step S105, through the network interface 9 (Step S201). Next, the print data analysis section 3 analyzes the print data received in Step S201 and generates image data for printing based on the predetermined configuration information (Step S202). More specifically, the print data analysis section 3 performs RIP process and generates image data for printing expanded into bitmap from print data. Next, the storage section 5 stores the image data for printing generated in Step S202 (Step S203).

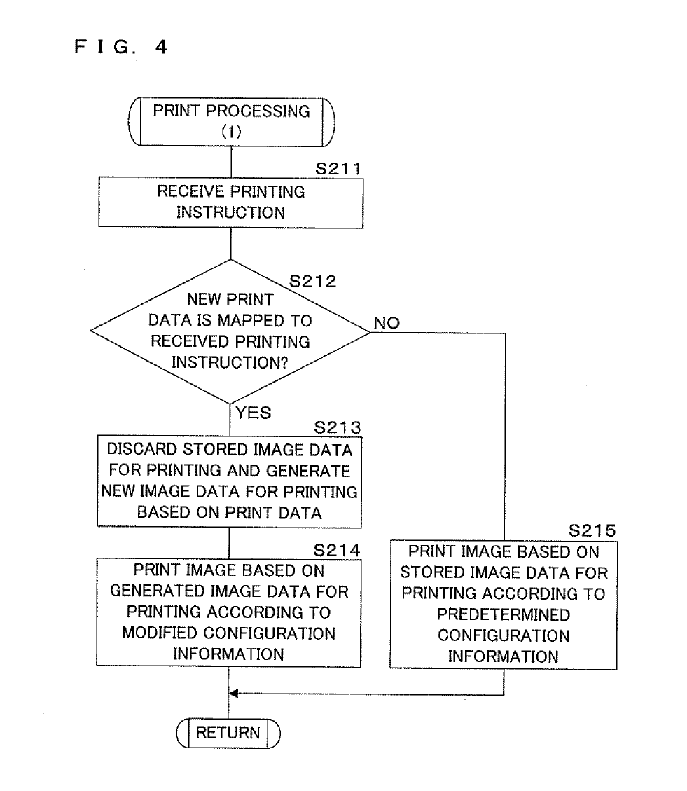

After Step S203, the print section 4 starts warming-up (Step S204). The print section 4 includes a fixing section (not shown) for the purpose of fixing the image formed by toner on the media. The definite time taken is required to reach at the sufficient temperature for fixing toner. By means of starting warming-up at the early stage, the printing can be done early in the after-mentioned process of FIG. 4. Next, a print processing is performed (Step S205). The after-mentioned processing of Step S205 includes the processing that the print apparatus 10 generates image data for printing and prints an image based on image data and the processing of deleting image data for printing from the storage section 5.

FIG. 4 is a flowchart showing a printing process based on the printing instruction executed by the print apparatus 10. The processing of FIG. 4 is executed in Step S205 of FIG. 3 based on the printing instruction and the like sent in Step S109 or Step S110 of FIG. 2.

With regard to FIG. 4, first of all, the control section 1 receives printing instruction through the network interface 9 (Step S211). The control section 1 judges whether new print data is mapped to the printing instruction received in Step S211 or not (Step S212). Namely, it is judged whether the printing instruction received in Step S211 is a printing instruction which is sent in Step S109 and to which print data and discard request are mapped or a printing instruction which is sent in Step S110.

In a case where new print data is mapped to the printing instruction (Step S212: YES), the control section 1 discards the image data for printing stored in the storage section 5, and the print data analysis section 3 generates new image data for printing based on the received print data mapped to the printing instruction received in Step S211 (Step S213). The print section 4 prints an image based on the image data for printing generated in Step S213 according to the print configuration information contained in the print data received in Step S211 (Step S214).

On the other hand, in a case where the new print data is not mapped to the printing instruction (Step S212: NO), the print section 4 prints an image based on the image data for printing stored in the storage section 5 according to the predetermined configuration information contained in the print data received in Step S201 (Step S215).

With regard to the processing from FIG. 2 to FIG. 4, predetermined configuration information is contained in print data. However, with regard to the embodiment of the present invention, the predetermined configuration information may be stored in the storage section 5 included in the print apparatus 10 in advance. In this case, the print data generated by the printer driver executed by the PC 70 does not contain configuration information in Step S104.

Moreover, the print data sent in Step S109 may also contain printing instruction. In this case, a discard request of the image data for printing based on predetermined configuration information and print data are sent in Step S109 and received in Step S211.

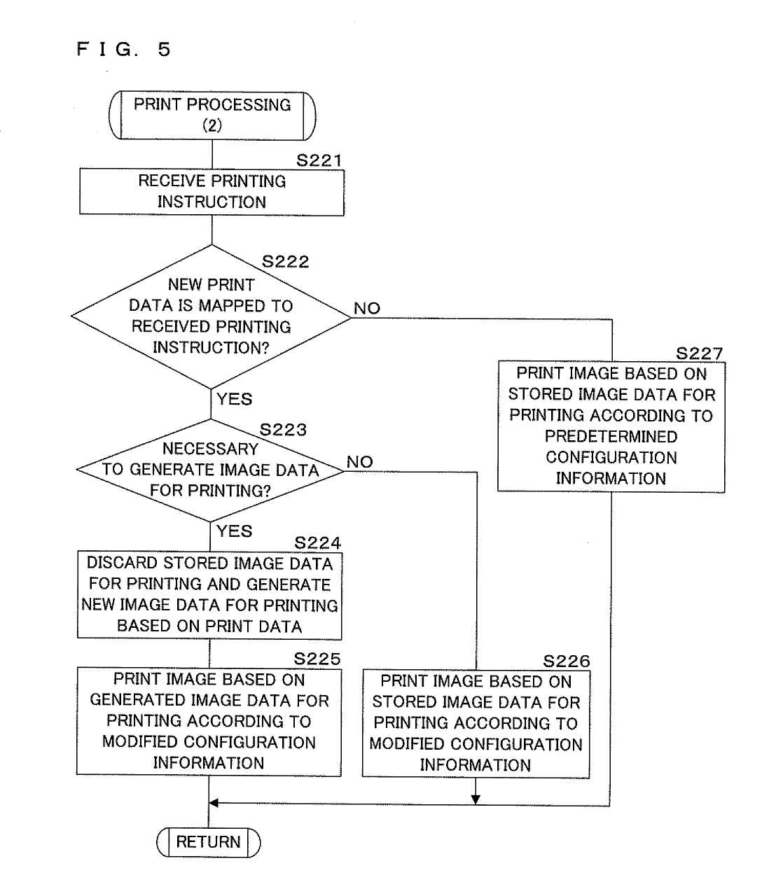

FIG. 5 is a flowchart showing a printing process based on the printing instruction executed by the print apparatus 10. The printing process of FIG. 5 is the modification of the process of FIG. 4. The process of FIG. 5 is executed in Step S205 of FIG. 3 based on the printing instruction and the like sent in Step S109 or Step S110 of FIG. 2.

With regard to FIG. 5, first of all, the control section 1 receives printing instruction through the network interface 9 (Step S221). The control section 1 judges whether new print data is mapped to the printing instruction received in Step S221 or not (Step S222). Namely, it is judged whether the printing instruction received in Step S221 is a printing instruction which is sent in Step S109 and to which print data and discard request are mapped or a printing instruction which is sent in Step S110.

In a case where new print data is mapped to the printing instruction (Step S222: YES), the print data analysis section 3 analyzes the print data mapped to the printing instruction received at Step S221, and the control section 1 judges whether it is necessary to generate new image data for printing or not (Step S223). Namely, it is judged whether the image data for printing based on the configuration information contained in the print data is the same as the image data for printing based on the predetermined configuration information stored in the storage section 5 or not.

Both of the configuration information are different, but both of the image data for printing are the same in the following cases, for example. Paper feed tray, copy receiving tray, number of copies, collating printing, stapling process and content, punching process and content, or cancellation of offset is different. In these cases, the image data for printing is not changed even if the configuration information is modified.

In a case where it is necessary to generate new image data for printing (Step S223: YES), the control section 1 discards the image data for printing stored in the storage section 5, and the print data analysis section 3 generates new image data for printing based on the received print data mapped to the printing instruction received in Step S221 (Step S224). Next, the print section 4 prints an image based on the image data for printing generated in Step S224 according to the print configuration information contained in the print data received in Step S221 (Step S225).

On the other hand, in a case where it is not necessary to generate new image data for printing (Step S223: NO), the print section 4 prints image based on the image data for printing stored in the storage section 5 according to the configuration information contained in the received print data mapped to the printing instruction received in Step S221 (Step S226). In a case where new print data is not mapped to the printing instruction (Step S222: NO), the print section 4 prints an image based on the image data for printing stored in the storage section 5 according to the predetermined configuration information contained in the print data received in Step S201 (Step S227).

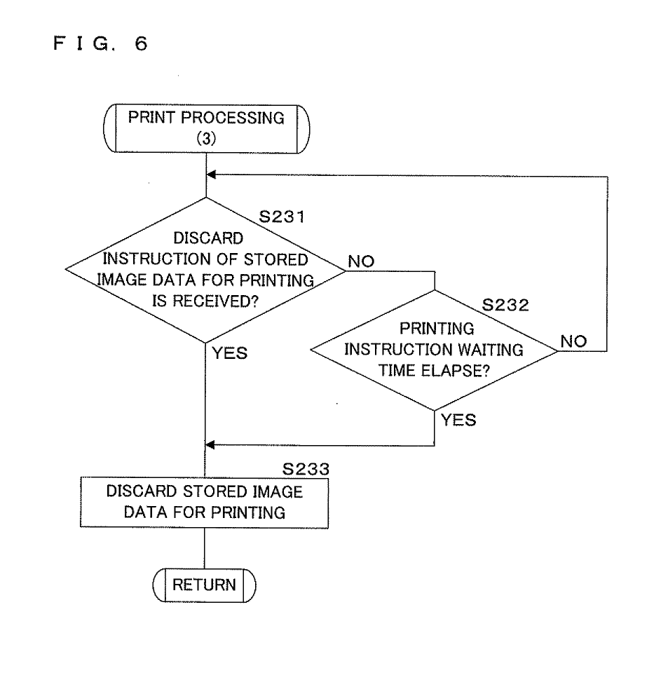

FIG. 6 is a flowchart showing a process of discarding image data for printing stored in the storage section 5 executed by the print apparatus 10. The processing of FIG. 6 is executed in Step S205 of FIG. 3. With regard to FIG. 6, the control section 1 initially judges whether a discard instruction of the image data for printing stored in the storage section 5 is received or not from the PC 70 through the network interface 9 (Step S231).

In a case where the discard instruction is not received (Step S231: NO), the control section 1 judges whether or not a predetermined time has elapsed in the status which the printing instruction is not inputted since the image data for printing is stored in the storage section 5 (Step S232). In a case where the predetermined time does not elapse (Step S232: NO), the procedure returns to Step S231.

In a case where the discard instruction is received (Step S231: YES), or in a case where the predetermined time elapses (Step S232: YES), the control section 1 discards image data for printing stored in the storage section 5 (Step S233). Accordingly, the storage region of the storage section 5 in which the image data for printing is stored can be ensured as the new free storage capacity.

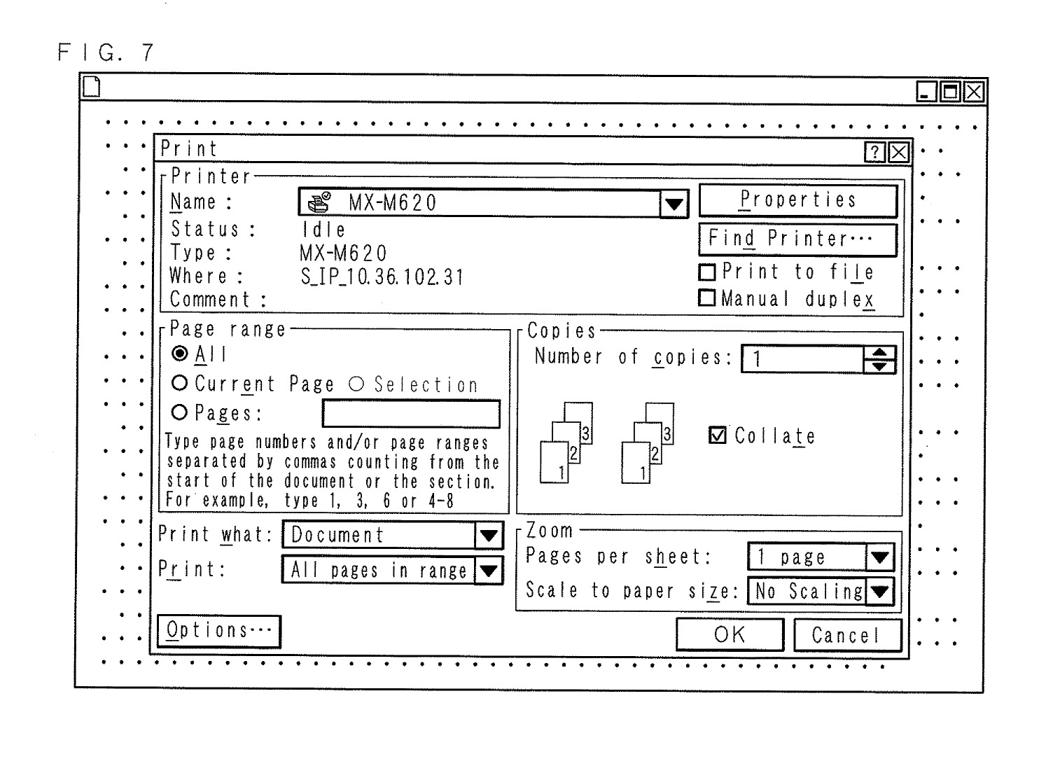

FIG. 7 is an explanatory view showing an example of an interface of a printer driver. The interface of FIG. 7 is displayed at the user interface 72 (e.g., not-shown display device) in the PC 70 as the operator instructs “Print” on the application for editing a document.

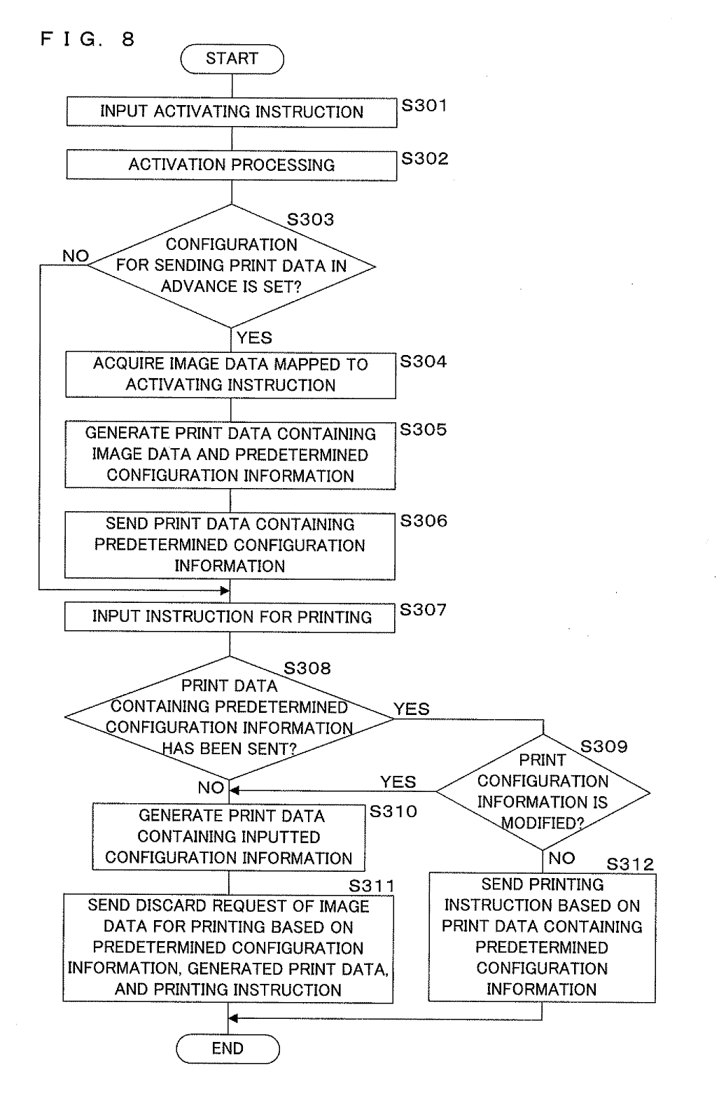

FIG. 8 is a flowchart showing a process in a case where the sending of print data containing predetermined configuration information can be configured regardless of whether an instruction is inputted by the operator or not. The processing of FIG. 8 is substantially same as the processing of FIG. 2. The difference between the processing of FIG. 2 and the processing of FIG. 8 is mainly described hereafter.

With regard to FIG. 8, first of all, the user interface 72 of the PC 70 receives an activating instruction inputted by the operator (Step S301). More specifically, the operator selects the printer driver and inputs the activating instruction through the application executed by the control section 71 of the PC 70. Accordingly, the activating instruction is inputted to the control section 71. Next, the control section 71 executes an activation processing for activating the printer driver (Step S302).

Next, the printer driver executed by the control section 71 judges whether sending print data in advance is configured or not (Step S303: YES). The configuration is inputted by the operator in advance through the user interface 72 for an example and stored in the storage section 75. In a case where the configuration is set (Step S303: YES), the processing from Step S304 to Step S306 is executed. The processing is similar to the processing from Step S103 to Step S105 illustrated in FIG. 2. In a case where the processing of Step S306 is completed, or in a case where the configuration is not set (Step S303: NO), the procedure is moved to Step S307.

The user interface 72 receives a printing instruction inputted by the operator, and the received printing instruction is inputted to the printer driver executed by the control section 71 (Step S307). Next, the printer driver executed by the control section 71 judges whether the print data containing predetermined configuration information has been sent or not (Step S308). In a case where the print data has been sent (Step S308: YES), it is judged whether the print configuration information is modified from the predetermined configuration information or not (Step S309). Namely, it is judged whether the operator inputs configuration information different from the predetermined configuration information through the user interface 72 or not after generating print data in Step S305.

In a case where the print data containing the predetermined configuration information has not been sent (Step S308: NO), or in a case where the print configuration information is modified (Step S309: YES), the printer driver executed by the control section 71 generates print data containing configuration information inputted from the user interface 72 (Step S310). Next, the printer driver executed by the control section 71 sends a request for discarding image data for printing based on the predetermined configuration information, the print data generated in Step S310, and the printing instruction to the print apparatus 10 through the network interface 79 (Step S311).

On the other hand, in a case where the print configuration information is not modified (Step S309: NO), the printer driver executed by the control section 71 sends printing instruction based on print data containing the predetermined configuration information to the print apparatus 10 through the network interface 79 (Step S312).

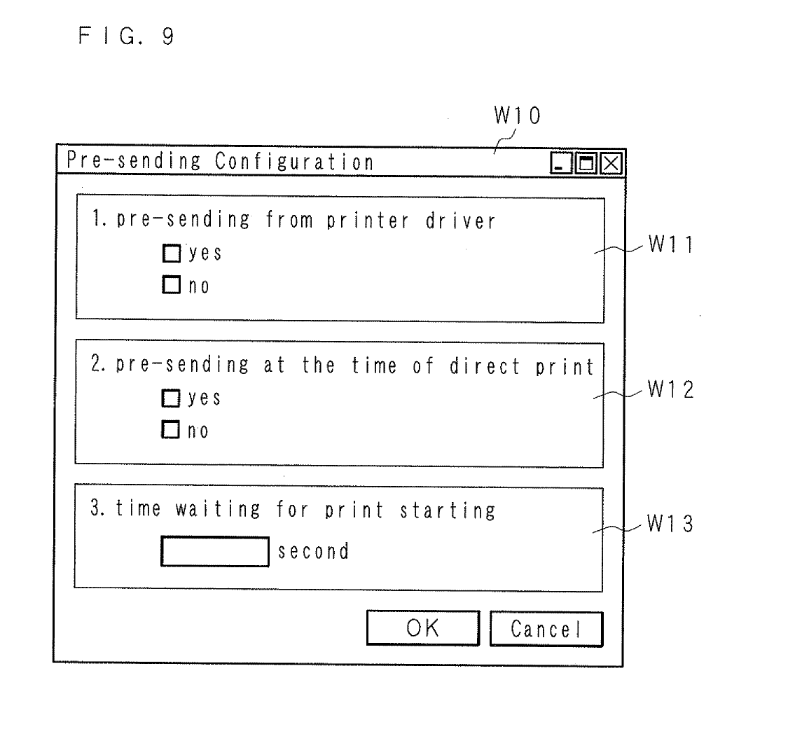

FIG. 9 is an explanatory view showing a screen for configuring sending of print data containing predetermined configuration information. With regard to FIG. 9, the sending of print data containing the predetermined configuration information is displayed as “pre-sending”. A screen W10 of FIG. 9 includes an entry field W11, an entry field W12, and an entry field W13.

Whether the pre-sending is performed in the printer driver or not is inputted into the entry field W11. Whether the pre-sending is performed in the direct print or not is inputted into the entry field W12. The time taken from the print apparatus 10 receiving the print data containing predetermined configuration information to deleting the image data for printing is inputted into the entry field W13.

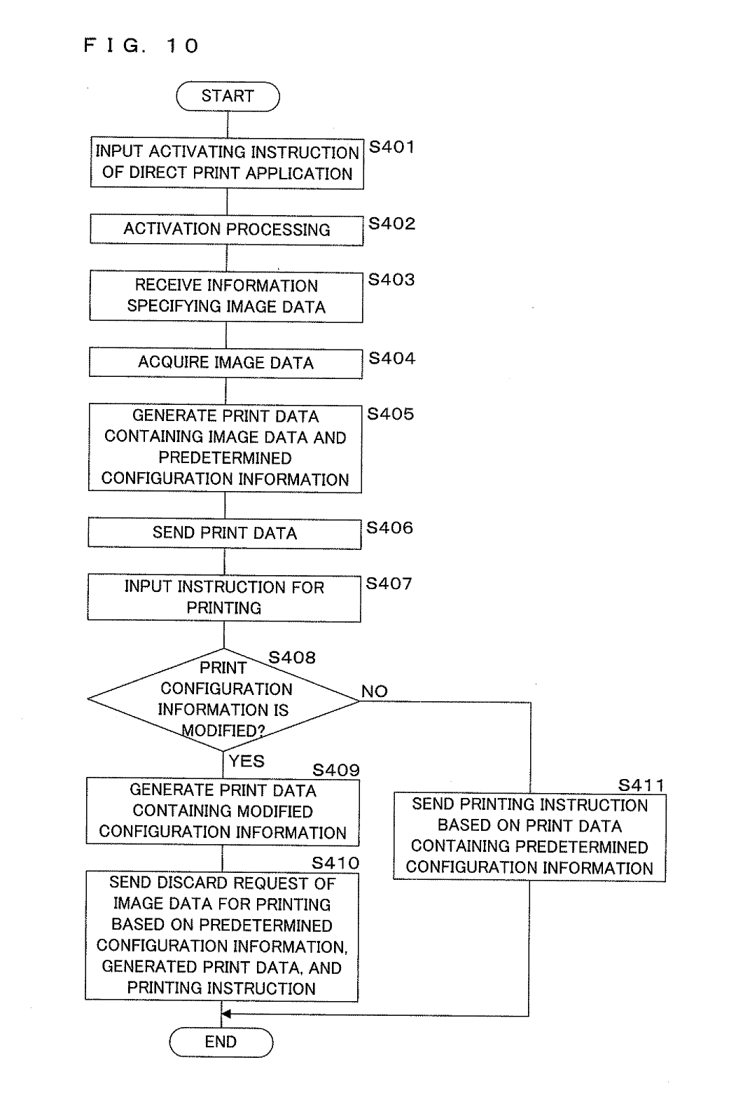

FIG. 10 is a flowchart showing a processing of generating image data for printing based on the direct print application activated upon the PC 70 and the print apparatus 10.

With regard to FIG. 10, first of all, the user interface 72 of the PC 70 receives an activating instruction inputted by the operator. More specifically, the operator specifies the URL of the direct print application upon the web browser. Accordingly, an activating instruction of direct print application is inputted to the control section 71 (Step S401). Next, the control section 71 executes an activation processing for activating direct print application (Step S402).

Next, the operator inputs information such as the filename of the image data in the field for entering information specifying image data on the browser, and the direct print application receives inputted information specifying image data (Step S403). The direct print application acquires image data based on the information specifying image data inputted in Step S403 (Step S404).

The direct print application generates print data containing image data acquired in Step S404 and the predetermined configuration information (Step S405). The direct print application sends the print data containing the predetermined configuration information generated in Step S405 to the print apparatus 10 through the network interface 79 (Step S406). Following upon Step S406, the processing from Step S407 to Step S411 is similar to the processing from Step S106 to Step S110 of FIG. 2. Therefore, the explanation is omitted.

On the other hand, the processing from Step S201 to Step S204 of FIG. 3 is executed in the print apparatus 10 based on the print data sent in Step S406.

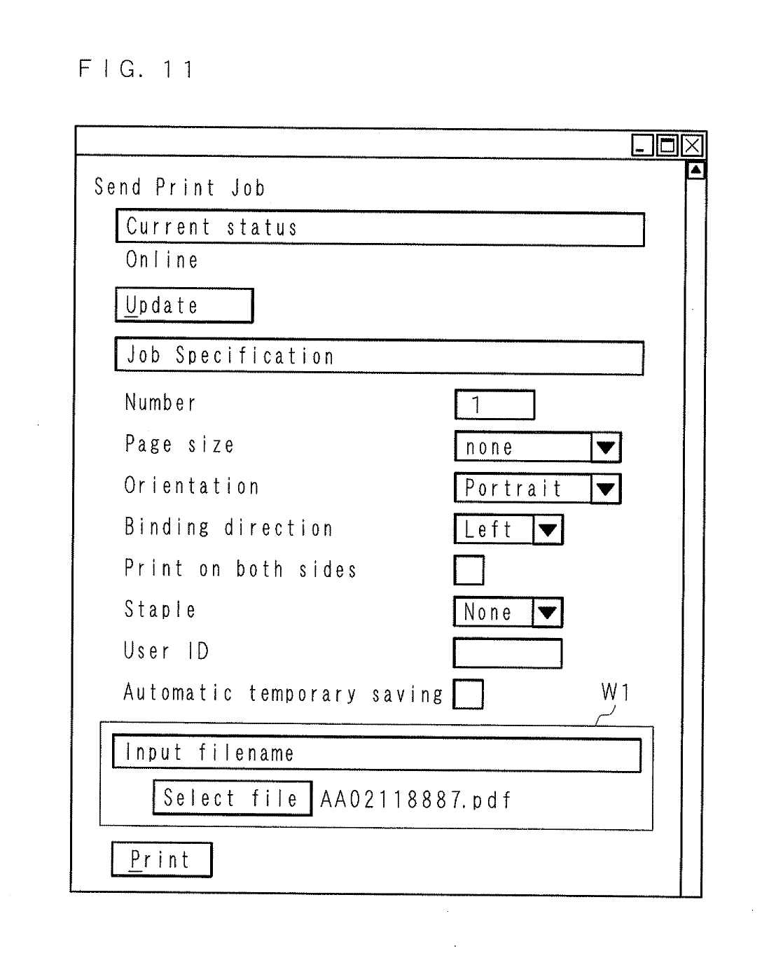

FIG. 11 is an explanatory view showing an interface of the direct print application displayed on the browser. With regard to FIG. 11, the operator inputs information specifying image data and clicks the object “Selecting File” in the entry field W1. Therefore, the processing of Step S403 of FIG. 10 is executed.

The program related to the embodiment of the print data generation apparatus and the print system causes a computer to carry out procedures executed by each apparatus. The program related to the embodiment is recorded in the recording media such as DVD, flash memory and hard disk. The program related to the embodiment is downloaded from an apparatus such as a server connected through the network and stored in a storage device (not-shown) in the computer. The program is read and executed by a CPU included in the computer.

The mode for carrying out the invention is explained above. However, the present invention is not limited to the embodiment described as the mode for carrying out the invention. It is possible to make variation within the scope of an object of the invention.

As this invention may be embodied in several forms without departing from the spirit of essential characteristics thereof, the present embodiment is therefore illustrative and not restrictive, since the scope of the invention is defined by the appended claims rather than by the description preceding them, and all changes that fall within metes and bounds of the claims, or equivalence of such metes and bounds thereof are therefore intended to be embraced by the claims.

What is claimed is:

1. A print system, comprising:
a print data generation apparatus that is activated through an inputted activating instruction and generates print data containing image data and configuration information at the time of printing an image based on the image data; and
a print apparatus that prints an image based on the print data generated by said print data generation apparatus;
wherein said print data generation apparatus includes:
an acquisition section that acquires image data according to the inputted activating instruction;
a generation section that generates print data containing the image data acquired by said acquisition section and predetermined configuration information; and
a sending section that sends the print data generated by said generation section to said print apparatus.

2. The print system according to claim 1,
wherein said print apparatus includes:
a receiving section that receives print data sent from said sending section;
an image generation section that generates image data for printing based on the print data received at said receiving section; and
a storage section that stores the image data generated by said image generation section.

3. The print system according to claim 2,
wherein said sending section sends a printing instruction to said print apparatus in a case where an instruction for printing based on print data containing the predetermined configuration information is inputted to said print data generation apparatus, and
said print apparatus includes a print section that prints, based on the predetermined configuration information, an image according to the image data stored in said storage section in a case where said receiving section receives the printing instruction.

4. The print system according to claim 3,
wherein, in a case where configuration information different from the predetermined configuration information is inputted to said print data generation apparatus, said generation section further generates print data containing image data acquired by said acquisition section and the inputted different configuration information, and
in a case where said receiving section receives print data containing the configuration information different from the predetermined configuration information, said print section further prints an image based on the received print data.

5. The print system according to claim 4,
wherein said print apparatus includes a judgment section that judges whether the image data generated from the received print data is the same as the image data stored in said storage section or not by comparing the configuration information contained in the print data received at said receiving section with the predetermined configuration information, and
said print section prints the image data stored in said storage section based on the configuration information contained in the received print data in a case where said judgment section judges that both image data are the same.

6. A print system, comprising:
a print data generation apparatus for generating print data containing image data specified by inputted information and configuration information at the time of printing an image based on the image data; and
a print apparatus that prints an image based on the print data generated by said print data generation apparatus;
wherein said print data generation apparatus includes:
an acquisition section that acquires image data specified by the inputted information;
a generation section that generates print data containing the image data acquired by said acquisition section and predetermined configuration information; and
a sending section that sends the print data generated by said generation section to said print apparatus.

7. A print data generation apparatus that is activated through an inputted activating instruction and generates print data containing image data and configuration information at the time of a print apparatus printing an image based on the image data, comprising:
an acquisition section that acquires image data according to the inputted activating instruction;
a generation section that generates print data containing the image data acquired by said acquisition section and predetermined configuration information;
a sending section that sends the print data generated by said generation section to said print apparatus.

8. A non-transitory computer-readable recording medium storing a computer program to cause a computer to activate through an inputted activating instruction and generate print data containing image data and configuration information at the time of a print apparatus printing an image based on the image data, the computer program comprising:
causing the computer to acquire image data according to the inputted activating instruction;
causing the computer to generate print data containing the acquired image data and predetermined configuration information; and
causing the computer to send the generated print data to said print apparatus.
